(19) United States
(12) Patent Application Publication
(10) Pub. No.: US 2020/0049177 A1
(43) Pub. Date: Feb. 13, 2020

(54) FLOATINGLY MOUNTED CLIP

(71) Applicant: A. Raymond et Cie SCS, Grenoble (FR)

(72) Inventors: Thomas PODSADNY, Salzhausen (DE); Michael DE JONG, Binzen (DE); Kevin MASCHAT, Rheinfelden (DE)

(21) Appl. No.: 16/341,325

(22) PCT Filed: Oct. 10, 2017
(86) PCT No.: PCT/EP2017/001196

§ 371 Date: Apr. 11, 2019

(30) Foreign Application Priority Data
Oct. 14, 2016 (DE) 10 2016 012 250.1

(51) Int. Cl. F16B 2/24; F16B 5/06

(52) U.S. Cl. CPC F16B 2/24; F16B 5/0642

(57) ABSTRACT

The invention relates to a clip for fastening a first element to a second element, in particular for the assembly of components for vehicles. The clip has a head with two wings extending from each other in the direction perpendicular to the longitudinal axis of the clip and a tip. The clip also has a first side and a second side, wherein the first side and the second side extend from the head towards the tip in the direction of the longitudinal axis of the clip, and the first and the second side are interconnected through the tip and can be compressed such that they can be moved towards each other around the tip. At least one side has a section that is farther away from the longitudinal axis than another section, wherein at least one wing at the wing end has a supporting surface that extends at least in sections at an angle of less than 45 degrees to the longitudinal axis of the clip.

### CROSS-REFERENCE TO RELATED APPLICATIONS

This application is the National Stage of International Application No. PCT/EP2017/001196, filed on 10 Oct. 2017, which claims priority to and all advantages of German Patent Application No. 10 2016 012 250.1, filed on 14 Oct. 2016, the content of which is hereby incorporated by reference.

### FIELD OF THE INVENTION

The invention generally relates to a clip for fastening a first element to a second element. In addition, the invention relates to a device comprising a first element and a second element fastened to the first element, wherein the first element has an opening in which the clip can be inserted, and the second element if fastened to the first element via such clip.

### BACKGROUND OF THE INVENTION

Clips for fastening a first element to a second element are known from U.S. Pat. Nos. 5,879,101 and 2,526,532. In U.S. Pat. No. 5,879,101, the clip has a head along with a tip. The clip described therein has a first side and a second side opposite the first side. The opposite sides extend from the head to the tip and have a mushroom-shaped profile. The head has two bent wings that hold the clip firmly in the opening of an element and pretension it. The wing ends are designed to be rounded. With the clip known from U.S. Pat. No. 2,526,532, the wings on the head of the clip are also directly adjacent to each other prior to, during and after mounting. The wing ends are divided in two. One part has the diameter of the opening and closes flush with the opening, while the other part grips behind the opening. Both parts fix the clip firmly in the opening of an element.

Against this background, the present invention was based on the task of proposing a clip for fastening a first element to a second element, which, when properly centered, would not only be more resistant to torsional and shear loads on the part located between the head and the tip, but would simultaneously also avoid an excessively rigid support when a first element is mounted on a second element, which often leads to deformation or damage to the clip.

### SUMMARY OF THE INVENTION

The present invention provides a clip and a device comprising a first element and a second element fastened to the first element with the clip. Advantageous embodiments are given in the dependent claims and the following description.

The invention is based on the fundamental idea of providing not only rounded or blunt wing ends on the head side to hold the clip in the opening of the first element holding the clip, but also additional supporting surfaces on the wing ends, which stabilize the clip perpendicular to its longitudinal axis, but nevertheless allow a translation of the clip in the latter direction in its clip holder.

A “clip” for fastening a first element to a second element is understood as a fastening device having at least a first contact surface and at least a second contact surface turned towards the first contact surface. As a rule, the first contact surface is provided at the head of the clip, which usually has two wings, while the second contact surface is provided between the head and tip of the clip. Such fastening devices are intended to be inserted with a tip in a recess, usually an opening, in the first element. The elastic element supporting the second contact surface is pressed in during insertion, but springs back to its initial position after complete insertion into the opening. The first element, at least in sections in the area of the opening, is usually designed as a flat element, for example as a plate or as a sheet of metal, in particular as a part of a vehicle frame. However, the first element may also have a blind hole with a correspondingly selected undercut, which allows the elastic element to spring out after it has passed a narrower part of the opening above the undercut. The second element can be fastened to the first element by clamping, for example if it is pushed between a head of the clip and a surface of the first element, and the distance of the first contact surface, which is then provided at the head of the clip, and the second contact surface of the clip is selected such that it can produce such clamping with a certain material thickness of the first element and a certain material thickness of the second element. It is also contemplated that the second element also has an opening and that the clip is guided with its tip through both holes. It is also contemplated for the second element to be fastened to the head of the clip if, for example, it has a hook or a fastening mushroom or if the second element is simply glued, welded or otherwise joined to the head of the clip.

A head of such a clip understood as a widening provided at one end of the clip. As a rule, the head is designed to prevent the clip from being pushed entirely through an opening in the first element.

The clip also has a tip. In the context of this description, “tip” refers only to the end of the clip opposite the head. In certain embodiments, a shaft of the clip extending from the head in the direction of the tip tapers towards the tip. However, this is not absolutely necessary. A tip in the context of this description is also understood as a blunt end to be provided in a conceivable embodiment at the end of a shaft opposite the head. In one embodiment, the tip may be tapered in pyramidal or conical or truncated pyramidal or truncated conical form. However, this is not absolutely necessary. The tip can be formed by a single section of the clip, for example by a vertex of an arch-shaped bending section.

Between the head and the tip, the clip has a shaft formed by the first side and the second side and, if desired, other parts.

The clip has a longitudinal axis that extends from the head to the tip. It is typical that the shaft is longer in its longitudinal extension pointing from the head to the tip than in a width direction perpendicular to the longitudinal extension. It is also typical that the longitudinal axis of the clip in the direction of the longitudinal extension has the shaft.

In certain embodiments, the clip is designed to be mirror-symmetrical with respect to a plane containing the longitudinal axis of the clip. In an alternative embodiment, the clip is designed to be rotationally symmetrical in such a manner that there is at least one plane containing the longitudinal axis of the clip, with which each section of the clip located on one side of such plane can be brought into alignment with an identically formed section of the clip on the other side of that plane via a 180° rotation about the longitudinal axis.

The clip according to the invention for fastening a first element to a second element has a head having two wings extending from each other in a direction perpendicular to the longitudinal axis of the clip and a tip and a first side and a second side, wherein the first side and the second side extend from the head in the direction of the longitudinal axis of the clip to the tip, wherein the first and second sides are interconnected through the tip and can be compressed such that they can be pivoted towards each other around the tip. At least one side has a section that is farther from the longitudinal axis than another section, wherein at least one wing at the wing end has a supporting surface that extends at least in sections at an angle of less than 45 degrees to the longitudinal axis of the clip, alternatively less than 35 degrees, alternatively less than 25 degrees, alternatively less than 15 degrees, alternatively less than 10 degrees. Though not required, it is typical that a section of the supporting surface provided at the wing end extends parallel to the longitudinal axis of the clip.

In this description, information regarding the spatial arrangements of parts of the clip refers—unless otherwise stated—to the clip in its unloaded, non-installed form. By inserting it into the opening of an element to be connected to another element, the clip can take on other shapes; for example, the two sides can be pivoted starting from one position in the unloaded state around the tip towards each other, and are held there by contact with the wall bounding the opening in the position pivoted towards each other. Unless otherwise stated, information regarding the spatial arrangements of parts of the clip does not refer to such an installation position; rather, it describes the clip as it lies uninstalled and unloaded by external forces on the table in front of a viewer.

In certain embodiments, the wing extends from a starting point closer to the longitudinal axis in the direction perpendicular to the longitudinal axis of the clip away from the longitudinal axis. The wing has a middle section between the supporting surface provided at the wing end and the starting point. This middle section can be formed by a section of the clip that is perpendicular to the longitudinal axis, for example a band section that is perpendicular to the longitudinal axis of the clip. However, in certain embodiments, the middle section is formed by sections of the clip, the extension of which has a component perpendicular to the longitudinal axis of the clip, but the extension of which also has a component parallel to the longitudinal axis of the clip.

In certain embodiments, the middle section of the wing extends from the starting point to a contact line or a contact surface of the wing provided at the transition from the middle section to the supporting surface, and thus of the head, and is provided to come into contact with one of the two elements to be joined together. In certain embodiments, the starting point of the wing in the direction of the longitudinal axis of the clip is at a distance from the contact line or the contact surface of the wing. It is typical that the starting point of the wing is arranged further away from the tip of the clip than the contact line or the contact surface. In certain embodiments, the distance of the starting point of the wing from the contact line or the contact surface in the direction of the longitudinal axis defines the maximum extension of the head in the direction of the longitudinal axis.

In certain embodiments, the length of the supporting surface (measured in the direction in which the supporting surface essentially extends) is longer than 20%, alternatively longer than 30%, alternatively longer than 40%, alternatively longer than 60alternatively longer than 80% of the maximum extension of the head in the direction of the longitudinal axis, wherein the maximum extension of the head in the direction of the longitudinal axis is understood to be the maximum distance, measured in the longitudinal direction, between the point of the head at the maximum distance from the tip in the longitudinal direction and the point at the minimum distance from the tip in the longitudinal direction. In certain embodiments, the length of the supporting surface (measured in the direction in which the supporting surface essentially extends) corresponds to the maximum extension of the head in the direction of the longitudinal axis. In certain embodiments, the length of the supporting surface (measured in the direction in which the supporting surface essentially extends) corresponds to the maximum extension of the head in the direction of the longitudinal axis and the distance of the starting point of the wing from the contact line or the contact surface in the direction of the longitudinal axis.

In particular, the head of the clip is understood as any part of the clip that is above a plane running perpendicular to the longitudinal axis of the clip and that contains a contact line or a contact surface of the wing and thus of the head that is provide to come into contact with one of the two elements to be connected.

In certain embodiments, the supporting surface is designed to be flat. It may be formed by a band-shaped element extending from the transition to the middle section of the wing. However, embodiments with which a curve shape or arcs bent several times to corners are also contemplated. For example, the supporting surface can be a reinforcement and/or a groove.

In certain embodiments, the width of the section of the clip forming the supporting surface (the direction perpendicular to the longitudinal axis of the clip and not in the thickness direction of the section of the clip forming the supporting surface) remains constant over the extension of the supporting surface. In an alternative embodiment, the width of the section of the clip forming the supporting surface is tapered.

In certain embodiments, at least one side of the clip has a side wall, wherein the side wall has one or more profiles and/or punched holes and/or reinforcements in the area of the area adjacent to the head. In the particular case of a cross-section of one side that is flat at least in sections, especially in the form of a flat band, e.g. comprising sheet metal, and/or in the case of cross-sections that are formed essentially in rounded or angular form at least in sections, modified geometries that are particularly advantageous in terms of stability and/or elasticity can be achieved by punched holes and/or deformations that are provided at least in sections. The term “punched hole” refers in particular to the manufacturing process of a certain profile by mechanical reshaping force but is used in the following as an equivalent for profiling. Typically, the punched holes run essentially in elongated form along the side and/or more or less parallel to the longitudinal axis of the clip. Zigzag and/or arch-shaped patterns, especially for adjusting the desired stiffness, are also contemplated. The cross-section in the area with a punched hole is especially formed to be arch-shaped, in particular curved or angular.

In a complementary or alternative embodiment, at least one side wall has one or more profiles and/or punched holes and/or reinforcements. A reinforcement in the form of a bulge is also contemplated here. Alternatively, a punched hole or deformation of one or more sections, in particular with a flat base body, is contemplated here, such that, especially, the contact surface on a clip holder and thus the friction during a translational movement is reduced.

In an additional embodiment, the head-side area of the side is designed as a band section. In this embodiment, the band section may be continued by an aligned band section that forms the part of the head. In these embodiments, such band section, which forms part of the head, may extend from the end point of the band section, which forms part of the side, to the starting point of the wing.

One of these two, in particular both, of such band sections, may be formed as a flat band, typically with a flat, in particular essentially rectangular cross-section or cross-sectional profile, e.g. comprising a band metal sheet.

In the assembled state, which will be explained in more detail below, the band section forming the head-side area of the side is located at least in sections in the area of an opening of an element, and may constitute a tapering of the clip.

It is typical that one of these two, in particular both, of such band sections, is formed to be essentially linear. In certain embodiments, one of these two, in particular both, of such band section has one or more profiles and/or punched holes and/or reinforcements.

In various embodiments, the band section runs essentially parallel to the longitudinal axis and, in particular in the unassembled state, is spaced from the band section of the second side. In particular, this allows more clearance and freedom of movement for the clip during and/or after its attachment to a second element.

In another embodiment, a section with at least one arc, the vertex of which forms the starting point of the wing in particular, is connected to the band section in the transition area to the wing. In particular, since the wings essentially extend outwards from the longitudinal axis of the clip, the section in the transition area from the band section to the wing has a deformation that may be formed as an arc, especially with multiple arcs. Analogous to the band section, such arch section in certain embodiments has one or more profiles and/or punched holes and/or reinforcements. For example, the same variation forms regarding the cross-section profile apply to the arch section as to the band section and/or the wing end.

To the extent that, in the context of the description, the term “band section” is discussed, such term, unless otherwise specified, is used solely to describe a flat section of an object, wherein the use of the term “band section” is intended to express that such flat section has a length and a width and a thickness that is significantly smaller than the length and width, in particular half, alternatively 5 times, alternatively 10 times, smaller than the length and width of such section, wherein the designation as a “flat section” does not rule out that the section has profiles and/or punched holes and/or reinforcements. Unless otherwise stated, the use of the term “band section” does not constitute a choice of material and, in particular, does not imply that the flat section must be made of a metal band. The flat section may also be made of non-metallic materials such as plastic, fiber-reinforced plastic or rubber.

In certain embodiments, the shaft and/or the profile of the first side is symmetrical to the shaft and/or the profile of the second side; in particular, both sides are opposite and in particular mirror-symmetrical to the longitudinal axis of the clip.

In particular, the tip formed by the sides is tapered in pyramidal or conical or truncated pyramidal or truncated conical or wedge-shaped form. The tip may also be formed by the ridge of a roof-shaped end section of a shaft extending from the head to the tip. In certain embodiments, the longitudinal axis of the clip cuts the tip.

It is also contemplated to have designs with which the shaft of the clip starts from the head with a first section of the first side and a first section of the second side, each extending in the direction of the tip, but then, between the first section of the first side and the sections of the clip forming the tip, others sections of the clip pointing in other directions, in particular in relation the extension of the first section of the first side, are provided, and/or then, between the first section of the second side and the sections of the clip forming the tip, other sections of the clip pointing in other directions, in particular in relation to the extension of the first section of the second side, are provided.

In certain embodiments, the first side has two contiguous sections running at an angle to each other, and the second side has two contiguous sections running at an angle to each other, which together with the tip form an essentially rhombus-shaped cross-section of such area of the clip, wherein the rhombus on the side opposite the tip has an opening defined by the distance of the first side to the second side. In certain embodiments, the band section described above in the context of the head-side area of the respective side is connected on the head side to the sections of the respective side involved in the formation of the rhombus.

In a specific embodiment, the clip has
a section of the first side forming a part of the previously described rhombus,
a band section of the first side, which is connected to such section on the head side,
a band section of the head, which is connected to such band section of the first side, and
a middle section of the wing, which merges into the band section of the head via an arc, and a profile and/or a punched hole and/or a reinforcement extending at least partially over such section of the first side, the two band sections and at least partially over the middle section of the wing.

In a further embodiment, the head and sides are all part of a one-piece element produced by the bending of sections of a metal section, e.g. comprising a band-shaped metal section. A clip made of plastic or a plastic-like material, which has elastic properties, is also conceivable. The clip can be made, for example, of fiber-reinforced plastic. For example, the clip according to the invention can be made of rubber-elastic material, in particular thermoplastic elastomer. Composite materials, with which the properties can be adjusted, in particular by the splitting ratio or the orientation of the materials, are also possible. It is also possible to manufacture the wing end from a different material, for example a more elastic or less elastic material, which can be connected to the clip via joining or clamping or adhesive processes.

The invention further comprises a device having a first element and a second element fastened to the first element, wherein the first element has an opening and the second element is fastened to the first element via a clip according to the invention, wherein the clip passes through the opening in such a manner that the head of the clip is arranged on one side of the opening and the tip of the clip is arranged on the opposite side of the opening.

In the embodiment according to the invention, the clip is held in the opening or recess of an element by the wings, for example by clamping or locking. To mount the clip, it is inserted into the opening or recess. In particular, the wings and/or sides are moved towards the inside of the clip for this purpose. After the introduction of the wings into the opening or recess, the wings and/or sides spread or move apart automatically.

In a specific embodiment, the wings have one or more supporting surfaces at the wing ends, which essentially run parallel to the longitudinal axis of the clip and/or perpendicular to the main plane of the first and/or second element. In particular, the supporting surfaces are designed to be essentially flat; these stabilize the clip, but nevertheless may permit a translation of the clip perpendicularly to the longitudinal axis of the clip and in particular in a defined direction of movement in its clip holder, especially up to the walls of the clip holder, which extend essentially parallel to the supporting surface.

In certain embodiments, the opening is connected to a blind hole of the first element. A blind hole is typically a hole or a recess that does not completely penetrate the workpiece like a through hole; that is, it has a certain depth. In addition, a blind hole may have an opening cross-section that is narrower than the lower area below. In particular, the deeper area below the opening has a basic shape that essentially has a rectangular cross-section.

The blind hole may be at least partially bounded by a boundary surface having a profile made of recesses and/or projections along a displacement direction of the clip, wherein the displacement direction runs at an angle to the longitudinal axis of the clip. The angle is typically greater than 45°, alternatively equal to 90°. The clip holder with a blind hole provided on the first element may have, on the planes perpendicular to the longitudinal axis of the clip and/or along the displacement direction, a profile of recesses and projections, which is designed in such a manner that it allows an improved automatic centering with a simultaneous floating mounting and/or floating seating of the clip in the clip holder. “Floating” means in particular that the clip holder has defined degrees of freedom for the clip in one or more spatial directions and/or spatial angles. The clip holder especially allows a relatively large translation perpendicular to the longitudinal axis of the clip compared to the other degrees of freedom.

Another conceivable form is a profile along the displacement direction that is curved, in particular in such a manner that, in the compressed state of the clip, a movement, in the longitudinal direction of the clip, is restricted. In particular prior to, especially during the assembly of the first element, the previously described evasive movement can ideally be carried out to its full extent, since the sides and/or wings are moved against the restoring force of the clip using an external force, thus shortening the distance between the wing ends and the supporting surface. This allows, in particular during assembly and disassembly, an increase in buckling stiffness along with an increase in tolerances in the positioning of the elements for assembly.

In an additional embodiment, the distance between the supporting surfaces is increased by applying disassembly forces, the force vectors of which run parallel to the longitudinal axis of the clip. This means that the device in this case has a higher holding and therefore disassembly force with improved self-centering properties, since the supporting surfaces of the wing ends abut against the lateral limits of the clip holder and/or push themselves off them and thus stabilize the clip in the clip holder. The recesses and/or projections of the clip holder are designed in such a manner that the clip has an increased restoring force into its target position when it moves from its target position. A centered step and/or one or more specially stepped projections and/or a profile in the form of a sinus pattern or a wave-like shape, which is especially symmetrical to the center of the opening of the blind hole, are conceivable here.

In an additional embodiment, the supporting surface is designed to be essentially complementary to the supporting surface on the clip holder, which will be described in more detail in a later section and is typically in the form of a blind hole.

In certain embodiments, the section of the side that is farther from the longitudinal axis than another section of such side is arranged closer to the tip than the other section, and the side between the section that is farther from the longitudinal axis than another section of such side and such other section has a transition section, in which the side progressively moves away from the longitudinal axis as it approaches the section farther from the longitudinal axis than another section of such side. In a specific embodiment, the side adjacent to the area farther from the longitudinal axis is designed in the direction of the tip in such a manner that it approaches the longitudinal axis once again from the area farther from the longitudinal axis in the direction of the tip. If the side of the clip is made of an elastic material, such shaping of the side of the clip may lead to the fact that, upon the insertion of the clip into an opening, the radius of which is smaller than the distance of the area that is farther from the longitudinal axis from the longitudinal axis of the clip, the area that is farther from the longitudinal axis is pressed in the direction of the longitudinal axis by contact with the wall of the opening and, after the area that is farther from the longitudinal axis has passed through the opening, returns to a position farther from the longitudinal axis due to the restoring force of the elastic material.

In various embodiments, the second element has an opening referred to as the second opening. It is typical that a part of the wall bounding the second opening or an edge forming the transition of the wall of the opening to a differently aligned surface of the second element is in contact with the transition section of the side. This makes it possible to hold the second element on the first element, in which the clip is formed with a contact line or contact surface turned towards the tip on its head, which may be formed by the transition from a central part of the wing to the supporting surface, is supported on a surface of the first element pointed away from the tip and passes through the second opening of the second element, and the area removed from the longitudinal axis is arranged on the other side of the second element further than the head of the clip. This brings a part of the wall bounding the second opening, or an edge forming the transition of the wall of the opening to a differently aligned surface of the second element, into contact with the transition section of the side. It is typical that the clip thereby also passes through an opening of the first element. It is obvious that, by selecting the position of the contact line or the contact surface at the head of the clip and selecting the position of the area that is farther from the longitudinal axis, and by designing the transition area of the side of the clip, it is possible to match the material thickness of the first element and the material thickness of the second element in the direction of the longitudinal axis of the clip, such that the clip is able to hold the first element and the second element with clamping force between the contact line or the contact surface turned towards the tip, at its head, and the transition section coming into contact with a part of the wall bounding the second opening or an edge that forms the transition of the wall of the opening to another aligned surface of the second element. The clamping force can be adjusted by selecting the material of the side, in particular the elasticity of the side, which determines how much the side springs back after being pushed through the opening of the second element. This design can also compensate for tolerances if the opening of the second element does not always have the same size due to production-related material deviations. Furthermore, by selecting the material, the force required to pull the clip back through the opening of the second element (to pull the tip of the clip back through the opening of the second element) can be set. Such embodiment offers advantages in particular in the case of the symmetrical design of the sides, for example in the case of the mirror-symmetrical design of the sides in relation to a plane containing the longitudinal axis of the clip.

In certain embodiments, the wing has a middle section between the supporting surface provided at the wing end and a starting point of the wing, wherein the middle section is formed by sections of the clip, the extension of which has a component in the direction perpendicular to the longitudinal axis of the clip and a component parallel to the longitudinal axis of the clip, and the middle section of the wing extends from the starting point up to a contact line or a contact surface of the wing and thus of the head provided at the transition from the middle section to the supporting surface, wherein the contact line or contact surface is in contact with a surface of the blind hole, and the starting point of the wing is arranged in a manner spaced from the contact line or contact surface of the wing and further away from the tip of the clip than the contact line or contact surface, and at the starting point of the wing, an additional contact line or contact surface, which is in contact with another surface of the blind hole, is provided. It is typical that the blind hole has a boundary surface running perpendicular to the longitudinal axis of the clip, with which the contact line or the contact surface of the wing provided at the transition from the middle section to the supporting surface is in contact. The additional contact line or contact surface provided at the starting point of the wing may be in contact with a boundary surface of the blind hole, which has a profile of recesses and/or projections along a displacement direction of the clip, wherein the displacement direction extends at an angle to the longitudinal axis of the clip.

In various embodiments, the surface of the blind hole with which the contact line or the contact surface of the wing provided at the transition from the middle section to the supporting surface is in contact is turned towards the other surface of the blind hole with which the additional contact line or contact surface provided at the starting point of the wing is in contact, and may run parallel to that of the other surface of the blind hole with which the additional contact line or contact surface provided at the starting point of the wing is in contact.

This embodiment offers advantages in particular in the case of the symmetrical design of the sides, in particular in the case of the mirror-symmetrical design of the sides in relation to a plane containing the longitudinal axis of the clip.

In various embodiments, the blind hole, as a deeper area below the opening, has a basic shape that essentially has a rectangular cross-section. With such a design, the surface of the blind hole with which the contact line or the contact surface of the wing provided at the transition from the middle section to the supporting surface is in contact may be formed by a first surface of the rectangle, and the other surface of the blind hole with which the additional contact line or contact surface provided at the starting point of the wing is in contact may be formed by another surface of the rectangle.

In various embodiments, the extension of the supporting surface in the direction parallel to the longitudinal axis of the clip is more than 0.1 mm smaller, alternatively more than 0.5 mm smaller, alternatively more than 1 mm smaller than the height of the blind hole measured in the direction parallel to the longitudinal axis in the area in which the supporting surface is located. This creates a clearance that prevents the free end of the supporting surface from scratching a boundary surface of the blind hole.

In various embodiments, the blind hole has two opposite boundary walls running parallel to the longitudinal axis. In a specific embodiment, one supporting surface of a wing in the installed state of the clip is in contact with one of the two opposite boundary walls running parallel to the longitudinal axis.

The clip according to the invention is may be used in particular to fasten a cover to a body component of a vehicle, in particular to fasten a cover to an A, B or C pillar of a body of a vehicle.

### BRIEF DESCRIPTION OF THE DRAWINGS

The invention is described in greater detail below with reference to the accompanying figure, in which:

FIG. 1 shows a side view perpendicular to the longitudinal axis of a clip according to the invention;

FIG. 2 shows a side view perpendicular to the longitudinal axis of the clip according to the invention with the clip rotated 90 degrees (or 270 degrees) about the longitudinal axis compared to FIG. 1;

FIG. 3 shows a side view perpendicular to the longitudinal axis of the clip according to the invention with compressed sides and/or compressed wings;

FIG. 4 shows a sectional view of a device according to the invention perpendicular to the longitudinal axis of the clip according to the invention with an assembled first element and an assembled second element;

FIG. 5 shows a sectional view of the device according to the invention perpendicular to the longitudinal axis of the clip according to the invention in the assembled state with the force load of the second element pointing away from the first element; and

FIG. 6 shows a sectional view of the device according to the invention perpendicular to the longitudinal axis of the clip according to the invention in the assembled state with the force load of the second element perpendicular to the longitudinal axis of the clip.

### DETAILED DESCRIPTION

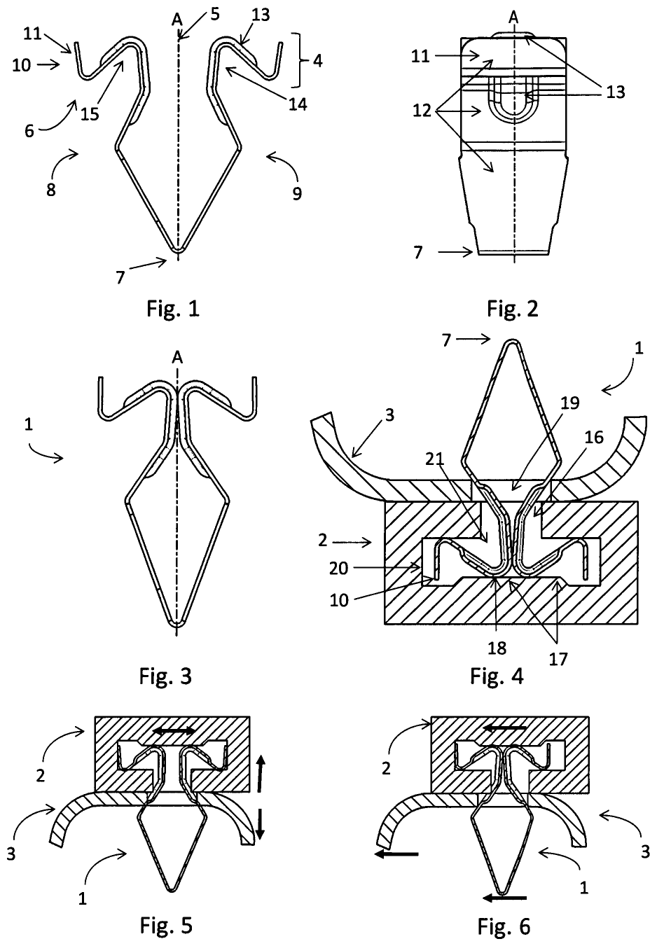

Referring to FIGS. 1-6, wherein like numerals indicate corresponding parts throughout the several views, a clip is illustrated and generally designated 1. In particular, in accordance with certain embodiments, the clip 1 shown in FIG. 1 in side views perpendicular to the longitudinal axis 5 for fastening a first element to a second element has a head 4 and a tip 7. Sides 8,9 composed of several, in particular bent, partial sections, which form a shaft, extend between the head 4 and the tip 7.

The shaft has a first side 8 and a second side arranged in a mirror-symmetrical manner opposite to the first side, in relation to a plane containing the longitudinal axis 5 of the clip. With the embodiment shown, the tip 7, together with parts of the tip, has a design tapered in pyramidal or conical or truncated pyramidal or truncated conical or wedge-shaped form. Both the first side 8 and the second side 9 extend from the head 4 in the direction of the tip 7, which connects the two sides 8,9. The tip 7 has an arch-shaped bending section that is bent inwards starting from the first side 8. The vertex of the arch of such bending section forms in particular the essential part of the tip 7. This is also followed by the second side 9. On the head side, the second side 9 along with the first side 8 ends in a partly arch-shaped bending section, which is bent outwards before the respective sides 8 and 9 merge into the band section 14. The band section 14 is essentially flat in cross-section and is formed to be straight or slightly curved in particular.

The band section 14 is followed by another arch section with an arch 15, which points outwards from the longitudinal axis of the clip and in particular represents the starting point of the wing 6. The wing 6 extends in a particularly curved section (middle part) up to the wing end 10, at which a supporting surface 11 is located. Here, the term “wing end” 10 is used to refer in particular to the flat end area that has an essentially straight-line course and adjoins an arch section that forms the transition between the middle section of the wing and the supporting surface and forms a contact line for making contact with one of the two components to be connected.

In particular, the supporting surface 11 is essentially parallel to the longitudinal axis 5 of the clip or has an angle of less than 45° to the longitudinal axis 5. The angle position is particularly dependent on the load condition of the clip. With the clip shown, for example, the angle to the longitudinal axis 5 is reduced upon the application of force pointing away from the head 4 and parallel to the longitudinal axis 5. In particular, the wing end 10 is also designed to be curved. In the area of the head 4, there are at least sections of profiles and or punched holes 13 and/or reinforcements, with which a specific bending strength can be achieved. Furthermore, the recess tongues 13 reduce friction on contact surfaces during and after mounting. The punched holes on the clip in FIG. 1 are in particular provided on the head-side area of the sides 8,9, on the belt section 14, on the arch 15 and on the middle part of the wing 6.

The clip according to the invention in the embodiment shown in the figures is a one-piece element and was produced by the bending of sections of a metal section, especially a sheet metal band.

In the specific embodiment shown in the Figs., each of the first side 8 and the second side 9 has a flat base body. FIGS. 1 and 2 show that the otherwise flat base body has elevations, particularly through punched holes. This makes it clear that, within the framework of this description, the term “flat base body” is used only in one embodiment to describe a geometrically exact flat base body, but in other design forms such as here such base bodies that deviate from a geometrically exact flat form due to small projections are also referred to as “flat base bodies.”

FIG. 2 shows a side view perpendicular to the longitudinal axis of the clip according to the invention with the clip rotated 90 degrees or 270 degrees about the longitudinal axis compared to FIG. 1. The flat base body or side wall tapers in the direction of the tip 7. The punched holes 13 are visible on the head side.

FIG. 3 shows a side view perpendicular to the longitudinal axis of the clip according to the invention with compressed sides and/or compressed wings. External forces typically bring the band sections 14 into contact and then insert them into the opening of element 2.

FIG. 4 shows a device according to the invention in a sectional view of the clip comprising the first element 2 and a second element 3 fastened to the first element 2, wherein the first element 2 has an opening and the second element 3 is fastened to the first element 2 via the clip. The clip passes through opening 16 in such a manner that the head 4 of the clip is arranged on one side of the opening 16 and the tip 7 of the clip is arranged on the opposite side of the opening 16 of the first element 2. The sides 8,9 are in contact with the second element, which is held in particular with clamping force. The clip is in a state that is mostly, but not yet finally, assembled state. The band sections 14 approach each other and the clip is centered in the opening 16, which connects to a blind hole 21. Furthermore, a step profile 17 can be seen on the lower bearing surface 18 for the clip in the blind hole 21; this is centered at the opening 16 and holds the clip in a typically fixed position in the assembled state. In the edge areas of the elongated blind hole 21, the device has more degrees of freedom for the movement of the head of the clip, such that the wing end experiences 10 less friction and can perform lateral translational movements, in particular during assembly.

In particular, the elastically compressible wing ends 10 have a bevel which, if the clip is inserted into a hole of a first element 2, causes it to come into contact with the edge of the hole and, through the further insertion of the clip, is pressed inwards against a spring force, but, after passing through the opening 16 in the first element, springs out again due to the spring force, and thereby engages behind the material of the first element 2 surrounding the opening 16.

A similar mechanism is provided for the attachment of the second element, wherein the truncated conical sides 8,9 are automatically compressed to the longitudinal axis 5 of the clip through the sliding open of a second element 3 with an additional opening 19.

FIG. 5 shows a sectional view perpendicular to the longitudinal axis of the clip according to the invention in the assembled state, with a force load of the second element 3 pointing away from the first element 2. A spreading of the wings can be seen, wherein the supporting surfaces 11 abut against the side surface 20 of the blind hole 21. Furthermore, the two band sections at the head 4 are further apart from each other than in the unloaded state. The deformations of the clip induced by the external force stabilize and center the clip automatically, in particular by the restoring force of the wing ends 10 and/or the sides partially or completely in contact with the elements 2,3.

FIG. 6 also shows a sectional view perpendicular to the longitudinal axis 5 of the clip according to the invention in the assembled state, but with the lateral force load of the second element 3 perpendicular to the longitudinal axis 5 of the clip. It can be seen here that a supporting surface 11 limits the translation of the clip in blind hole 21 on one side, and that the supporting surface 11 is in contact with the side surface 20 of the blind hole 21; it is especially flush with it. The band sections 14 approach each other and second element 3 is shifted laterally along the plotted force vector relative to the element 2. The device thus allows a limited, reversible translational movement of both elements relative to each other, particularly under the application of force perpendicular to the longitudinal axis 5.

### DESIGNATIONS

1. Clip

2. First element

3. Second element

4. Head

5. Longitudinal axis

6. Wing

7. Tip

8. First side

9. Second side

10. Wing end

11. Supporting surface

12. Side wall

13. Punched holes

14. Belt section

15. Arch

16. Opening

17. Profile

18. Bearing surface

19. Second opening

20. Side surface

21. Blind hole

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

The term “about” as used herein serves to reasonably encompass or describe minor variations in numerical values measured by instrumental analysis or as a result of sample handling. Such minor variations may be in the order of ±0-25,±0-10,±0-5, or ±0-2.5,% of the numerical values. Further, The term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A clip for fastening a first element to a second element, wherein the clip comprises:
a head having two wings extending from each other in the direction perpendicular to the longitudinal axis of the clip and a tip, and
a first side and a second side, wherein the first side and the second side extend from the head towards the tip in the direction of the longitudinal axis of the clip,
wherein the first side and the second side are interconnected through the tip and can be compressed such that they can be pivoted towards each other around the tip
wherein at least one of the first and second sides has a section that is farther away from the longitudinal axis than another section of that side, and
wherein at least one wing at a wing end has a supporting surface that extends at least in sections at an angle of less than 45 degrees to the longitudinal axis of the clip.

2. The clip according to claim 1, wherein at least one side has a side wall, wherein the side wall has one or more profiles and/or punched holes and/or reinforcements in an area adjacent to the head.

3. The clip according to claim 1, further comprising a band section connected to the side on a head side.

4. The clip according to claim 3, wherein a section with at least one arch is connected to the band section in a transition area to the wing.

5. The clip according to claim 1, wherein the clip is mirror-symmetrical with respect to a plane containing the longitudinal axis of the clip.

6. The clip according to claim 1, wherein the head and the first side and the second side are part of a one-piece element produced by the bending of sections of a metal section.

7. A device having a first element and a second element fastened to the first element, wherein the first element has an opening and the second element is fastened to the first element via the clip according to claim 1, wherein the clip is disposed through the opening in such a manner that the head of the clip is arranged on one side of the opening and the tip of the clip is arranged on the opposite side of the opening.

8. The device having a clip according to claim 7, wherein the opening of the first element is followed by a blind hole.

9. The device according to claim 8, wherein the blind hole is at least partially bounded by a boundary surface having a profile made of recesses and/or projections along a displacement direction of the clip, wherein the displacement direction runs at an angle to the longitudinal axis of the clip.

10. The device according to claim 9, wherein the profile of the blind hole along the displacement direction curved.

11. The device according to claim 8, wherein the recesses and/or projections of the blind hole are designed in such a manner that they work together with projections and/or recesses at the head of the clip, such that the clip is automatically centered in the blind hole.

12. The device according to claim 7, wherein the section of the side that is farther away from the longitudinal axis than another section of such side is arranged closer to the tip than the other section, and wherein the side between the section that is farther from the longitudinal axis than another section of such side and such other section has a transition section, in which the side progressively moves away from the longitudinal axis as it approaches the section farther from the longitudinal axis than another section of this side.

13. The device according to claim 12, wherein the second element has a second opening and a part of the wall bounding the second opening or an edge forming the transition of the wall of the second opening to a differently aligned surface of the second element is in contact with the transition section of the side.

14. The device according to claim 8, wherein the wing has a middle section between the support surface provided at the wing end and a starting point of the wing, wherein the middle section is formed by sections of the clip, the extension of which has a component in the direction perpendicular to the longitudinal axis of the clip and a component parallel to the longitudinal axis of the clip, and wherein the middle section of the wing extends from the starting point to a contact line or a contact surface of the wing and thus of the head provided at the transition from the middle section to the supporting surface, wherein the contact line or the contact surface is in contact with a surface of the blind hole, and the starting point of the wing is arranged in a manner spaced from the contact line or contact surface of the wing and farther away from the tip of the clip than the contact line or contact surface, and at the starting point of the wing, an additional contact line or contact surface, which is in contact with another surface of the blind hole, is provided.

15. The device according to claim 7, wherein the extension of the supporting surface in the direction parallel to the longitudinal axis of the clip is more than 0.1 mm smaller than the height of the blind hole measured in the direction parallel to the longitudinal axis in the area in which the supporting surface is located.

16. A method of forming the device of claim 7, said method comprising disposing the clip through the opening in such a manner that the head of the clip is arranged on the one side of the opening and the tip of the clip is arranged on the opposite side of the opening.
